(19) United States
(12) Patent Application Publication
(10) Pub. No.: US 2003/0229512 A1
(43) Pub. Date: Dec. 11, 2003

(54) System and method for operating a long term care facility

(76) Inventor: William R. Lenhard II, Baltimore, MD (US)

Correspondence Address: Finnegan, Henderson, Farabow,, Garrett & Dunner, L.L.P., 1300 I Street, N.W., Washington, DC, 20005-3315, US

(21) Appl. No.: 10/163,693

(22) Filed: Jun. 6, 2002

(51) Int. Cl. G06F 17/60

(52) U.S. Cl. 705/2

(57) ABSTRACT

To operate a long term care facility, a resident's behavior is observed and entered into an input device where it is transmitted to an observation processing system and stored in a database. Based on the observation, the processing system provides information to the input device for display to a caregiver. The observation and/or information may also be transmitted to an authorized person.

### CROSS-REFERENCE TO RELATED APPLICATION

This application claims the priority benefit of U.S. Provisional Application No. 60/295,853, filed on Jun. 6, 2001, which is incorporated herein by reference.

### FIELD OF THE INVENTION

The present invention generally relates to systems and methods for operating a long term care facility.

### BACKGROUND OF THE INVENTION

The Long Term Care (LTC) industry is experiencing widespread and catastrophic problems including bankruptcy, high staff turnover, resident dissatisfaction and departure, abuse and neglect allegations, insurance rate increases, litigation, and governmental regulations. Despite these problems, the market for the LTC industry continues to grow. The number of persons in America age 65 and older will double from 35 million to 79 million between the years 2000 and 2030. Presently, 6.5 million older Americans need help with daily living. This number is projected to double by 2010. Further, 600,000 additional LTC facility caregivers will be needed by 2011. The state of the LTC industry, coupled with the inevitable increase in elder population, threaten to not only exacerbate these problems, but also further erode the national confidence in LTC facilities and their financial viability.

Instead of focusing on the needs of the residents, today's LTC industry focuses on products and services. Further, LTC facility caregivers lack the skills, the tools, and the motivation to effectively assess the needs of the residents. Still further, there are no adequate staff training curricula focused on reducing staff turnover rates and increasing job performance.

Accordingly, there is a need in the LTC industry for a business model that focuses on the needs of the residents. Further there is a need in the LTC industry for training programs for LTC facility caregivers.

### SUMMARY OF THE INVENTION

In accordance with the invention, there is provided a method for operating a long term care facility comprising observing a resident's behavior, entering at least one observation in an input device and receiving information from the input device based on the at least one observation. There is also provided a method for operating a long term care facility comprising providing training to a caregiver on age related issues, providing training to a caregiver on how to recognize a problem in a resident, providing training to a caregiver on how to respond to a problem in a resident, and providing an input device for entering an observation and receiving information based on the observation.

There is further provided a system for operating a long term care facility comprising means for entering an observation and means for receiving information based on the observation.

Still further, there is provided a computer readable medium containing instructions for controlling a computer system to perform a method comprising receiving electronically at least one observation, providing information electronically based on the at least one observation, and storing the at least one observation in a database. There is also provided a computer readable medium containing instructions for controlling a computer system to perform a method comprising providing training to a caregiver on age related issues, providing training to a caregiver on how to recognize a problem in a resident, providing training to a caregiver on how to respond to a problem in a resident, and receiving an observation and providing information based on the observation.

Advantages of the invention will be set forth in part in the description which follows, and in part will be obvious from the description, or may be learned by practice of the invention. The advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1A illustrates an environment in which traditional LTC facilities operate.

FIG. 1B illustrates an environment in which to practice the systems and methods consistent with the present invention.

FIG. 2 illustrates a method for operating a LTC facility consistent with the present invention.

FIG. 3 illustrates a method for providing training to a caregiver.

FIG. 4 illustrates a method for operating a LTC facility consistent with the present invention from a caregiver's point of view.

FIG. 5 illustrates a method for operating a LTC facility consistent with the present invention from an observation processing system's point of view.

### DESCRIPTION OF THE EMBODIMENTS

Reference will now be made in detail to the exemplary embodiments of the invention, examples of which are illustrated in the accompanying drawings. Wherever possible, the same reference numbers will be used throughout the drawings to refer to the same or like parts.

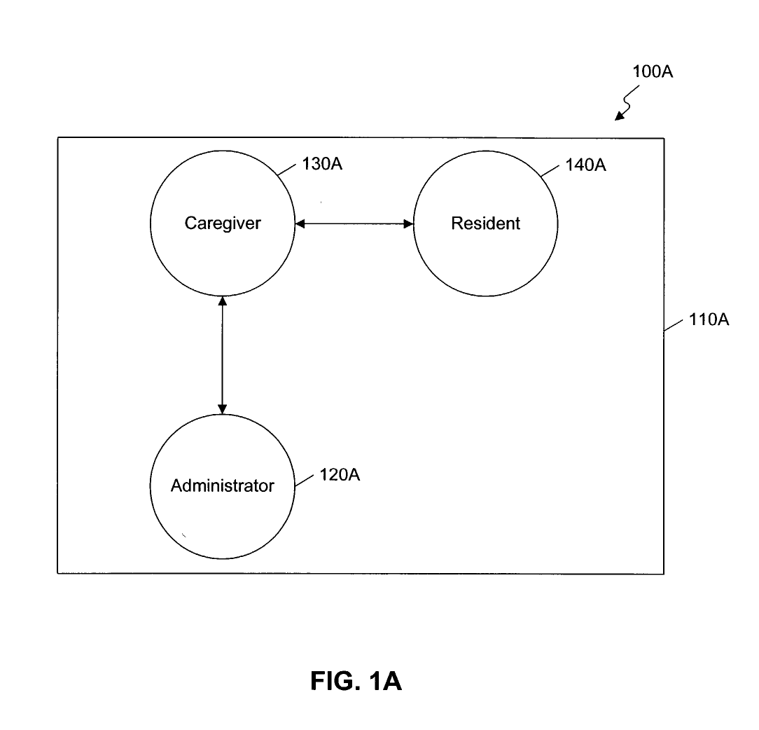

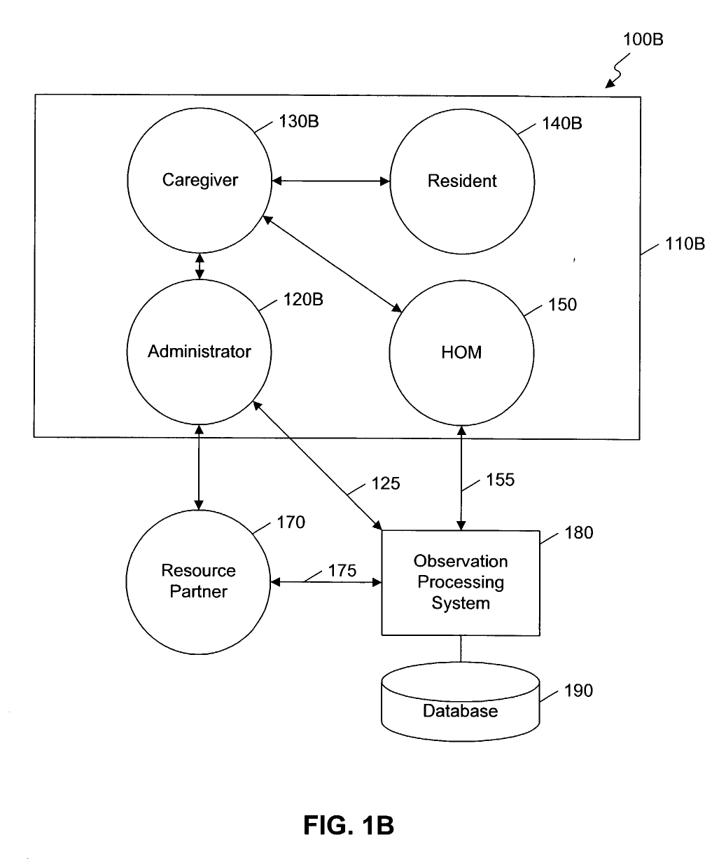

FIG. 1A illustrates an environment 100A in which traditional LTC facilities 110A operate. Environment 100A comprises one or more LTC facilities 110A, each having one or more administrators 120A, one or more caregivers 130A, and one or more residents 140A.

Traditional LTC facilities 110A are designed based on a medical model. Under the medical model, caregiver 130A is trained to function similar to an assistant in a hospital. For example, caregiver 130A is trained to take resident's 140A temperature and give resident 140A medicine. There is no training on how to evaluate the physical and/or emotional needs of residents 140B. Accordingly, today's caregivers 130A lack the skills, the tools, and the motivation to make assessments of the needs of residents 140A. Further, under the medical model, traditional LTC facilities 110A focus on delivering products and services instead of focusing on the needs of residents 140A. While operating a LTC facility 110A based on a medical model may be effective for healing, the medical model does not bring satisfaction to residents 140A, resulting in high dissatisfaction departures by residents 140A or depression in those residents 140A that remain at the LTC facility 110A.

According to social science and medical research, general health is positively correlated with a sense of well-being, fulfillment, and happiness. Therefore, it is absolutely essential that a LTC facility develop a culture that facilitates positive emotions in residents 140A. Unfortunately, the current LTC facilities 110A have failed to provide a culture that facilitates positive emotions in residents 140A. Instead, the LTC industry has built LTC facilities 110A expecting residents 140A to adjust to the facilities 110A instead of adjusting the facilities 110A to meet the emotional needs of residents 140A. Further, traditional LTC facilities 110A are not designed to handle the changing needs of residents 140A as they age. Still further, caregivers 130A are generally fatigued, disinterested, poorly managed, and under-trained, resulting in abuse and neglect of residents 140A.

Being acutely sensitive and vigilant to the needs of residents 140A is one of the keys to reducing risk, providing quality service, and increasing resident 140A satisfaction. Accordingly, LTC facilities 110A need to become skilled at observing, recognizing, capturing, and acting upon the needs of residents 140A. Administrators 120A must understand the needs of residents 140A including the psychological needs of residents 140A and the emotional issues affecting residents 140A. Further, administrators 120A must ensure that caregivers 130A have sufficient knowledge of the needs of residents 140A, sufficient intervention skills, and are trained to adjust to the changing level of services required by residents 140A as they age. Still further, administrators 120A must understand and manage culture to provide meaningful satisfaction to residents 140A and caregivers 130A.

Accordingly, systems and methods for operating a LTC facility consistent with the present invention focus on the needs of the residents. Further, systems and methods for operating a LTC facility consistent with the present invention provide a culture that facilitates positive emotions in the residents. Still further, systems and methods for operating a LTC facility consistent with the present invention staff the LTC facility with trained caregivers focused on the needs of the residents.

Focusing on the needs of resident 140A may be achieved by increasing caregiver's 130A knowledge of aging, increasing caregiver's 130A skill sets (i.e., action specific responses to the resident's needs), and improving caregiver's 130A attitude. A caregiver's 130A knowledge, skill sets, and attitude is known collectively as Behavior Capital™. Caregiver's 130A Behavior Capital™ may be improved through curriculum training. However, improving Behavior Capital™ may not change a caregiver's 130A actions. Behavior Capital™ may only be useful in a framework of rules, guidelines, and incentives that govern the complex nature of staff actions and interactions (i.e., culture).

Accordingly, systems and methods for operating a LTC facility consistent with the present invention facilitate improving a caregiver's Behavior Capital™ and providing a framework of rules, guidelines, and incentives for changing a caregiver's actions.

Uniform, consistent, and predictable actions by caregivers 130A are also required to reduce risk, provide quality service, and increase resident 140A satisfaction. Successful behavioral change is a function of the frequency and quality of personnel monitoring, management, and maintenance activities. In a workplace, it is very difficult to provide a continuous flow of personnel monitoring, management, and maintenance activities. Even in the best workplace environments, only intermittent management and direction is possible. In the LTC industry, caregivers 130A are given limited guidance by administrators 120A who are generally distant to the activities and the realities of caregivers 130A. As a result, caregivers' 130A behavior may be inconsistent and unpredictable.

To achieve uniform, consistent, and predictable actions by caregivers 130A that reduce risk, provide quality service, and increase resident satisfaction, universal controls over caregivers' 130A actions that concentrate caregivers' 130A attention on the needs on residents 140A are required. Systems and methods for operating a LTC facility consistent with the present invention provide universal controls over caregivers' 130A actions to ensure uniform, consistent, and predictable actions by utilizing a handheld observation manager (HOM™).

Further, training caregivers 130A in the habit and process of observing residents 140A may concentrate caregivers' 130A attention on residents 140A thereby reducing risk, providing quality service, and increasing resident satisfaction. Training caregivers 130A in the habit and process of observing residents 140A also enables anticipating and solving problems before they occur. For example, if a caregiver 130A is trained to observe the type of shoes resident 140A is wearing, caregiver 130A may prevent a fall by observing that resident 140A is wearing inappropriate shoes and assisting resident 140A in replacing the shoes for more appropriate shoes.

Accordingly, systems and methods for operating a LTC facility consistent with the present invention provide training to caregiver 130A in the habit and process of observing residents 140A. HOM™ in combination with caregiver training provide universal controls over caregivers' 130A actions that concentrate caregivers' 130A attention on the needs on resident 140A.

FIG. 1B illustrates an environment 100B in which to practice the systems and methods consistent with the present invention. Environment 100B comprises one or more LTC facilities 110B, a resource partner 170, an observation processing system 180, and a database 190. Each LTC facility 110B comprises one or more administrators 120B, one or more caregivers 130B, one or more residents 140B, and one or more handheld observation managers (HOMs™) 150. Observation processing system 180 includes a processor (not shown) comprising computer instructions for implementing methods consistent with the present invention.

LTC facility 110B may include any senior housing facility such as a nursing home, assisted living facility, independent living facility, board and care home (a/k/a adult family home, adult foster care, or group home), continuing care retirement community, adult day care facility (a/k/a senior day care facility), home health care facility, hospice facility, or hospital. The LTC facility 110B may be public, private, for profit, non-profit, licensed, unlicensed, or any combination of the foregoing.

For each LTC facility 110B, administrator 120B manages LTC facility 110B including caregivers 130B. Resource partner 170 may be a person or entity that provides assistance to administrator 120B in operating LTC facility 110B consistent with the teaching of the present invention.

Caregivers 130B observe and interact with residents 140B. HOM™ 150 maybe a handheld device (e.g., a palm pilot) that is used by caregiver 130B to enter observations. These observations are transmitted to the database 190 via connection 155. The data stored in database 190 may be retrieved by or transmitted to administrator 120B and resource partner 170 via connections 125 and 175, respectively. In addition, the data stored in database 190 may be retrieved by or transmitted to a family member, a solution provider (e.g., a physician), or any other authorized person or entity. For example, the data may also be transmitted to a regulatory entity such as Medicare.

Connections 125, 155, 175 may be any system, network, or device that facilitates communication (e.g., data communication or telecommunication) using any appropriate communication protocol (e.g., TCP/IP, HTTP, HTTPS or any other security protocol, FTP, SMTP, or any other proprietary protocol). Connections 125, 155, 175 may comprise a local area network (LAN) connection, a wide area network connection, an Internet connection, or a combination of the foregoing. Connections 125, 155, 175 may also comprise a telephone line, optical fiber, coaxial cable, twisted wire pair, or a combination of the foregoing. In addition, connections 125, 155, 175 may be a wireless connection using any appropriate technique to provide wireless transmission including infrared line of sight, cellular, microwave, satellite, packet radio, spread spectrum, or a combination of the foregoing.

Generally, caregiver 130B uses HOM™ 150 to report observations of resident 140B and to receive instructions on how to interact with resident 140B based on the observation. Caregiver 130B may observe and report general conditions (e.g., weather, conditions in a room, etc.) and incidents (e.g., accidents, emotional outburst, etc.). Generally, for each observation, caregiver 130B reports resident's 140B activity (i.e., what resident 140B is doing), resident's 140B location, and the time of day. For example, caregiver 130B may observe and report that resident 140B is sifting in the recreation room, eating in the dining room, standing and talking in the courtyard, or sleeping in the bedroom. The amount and frequency of the observations may be any amount and frequency that reliably reflects the conditions of the environment and the profile of resident 140B.

Caregiver 130B may also observe and report resident's 140B response to caregiver's 130B interactions with resident 140B. For example, suppose caregiver 130B observes that resident 140B is unhappy and enters this observation in HOM™ 150. Caregiver 130B may receive via HOM™ 150 one or more solutions for making resident 140B happy. For example, HOM™ 150 may suggest that caregiver 130B turn on the television, greet resident 140B, or pat resident 140B on the back. Caregiver 130B may implement one or more of the solutions and observe and record resident's 140B response to each solution. For example, if caregiver 130B turns the television on but resident 140B is unresponsive, then caregiver 130B may observe and report resident's 140B unresponsiveness to turning on the television. If caregiver 130B greets resident 140B and resident 140B smiles, then caregiver 130B may observe and report that resident 140B smiled in response to a greeting. This information may be used in the future to determine the appropriate solution for making resident 140B happy. For example, it may be determined based on past reported observations that resident 140B does not like watching television. Therefore, HOM™ 150 may not return a solution to turn on the television when caregiver 130B enters an observation that resident 140B is unhappy. Instead, based on past reported observations, HOM™ 150 may return a solution to caregiver 130B to greet resident 140B.

HOM™ 150 may comprise observation menus providing a plurality of predetermined observations, which caregiver 130B may pick and select to enter observations. Providing predetermined observation allows caregiver 130B to efficiently report observations. For example, if caregiver 130B observes a particular behavior, then caregiver 130B may pick the appropriate menu and select the appropriate behavior.

HOM™ 150 may include a menu having a list of mutually exclusive behaviors. These mutually exclusive behaviors (i.e., behaviors that resident 140B may not perform concurrently) may include sitting, standing, lying, walking, running, etc. HOM™ 150 may also include a menu having a list of concomitant behaviors (i.e., behaviors that resident 140B may perform concurrently) such as smoking, talking, play cards, watching television, etc. HOM™ 150 may include a menu having a list of locations in LTC facility 110B (e.g., dining room, bedroom, recreation room, courtyard, etc.). Still further, HOM™ 150 may include a menu having a list of foods and drinks. HOM™ 150 may also include a menu having a list of medications (e.g., prescription or over-the-counter drugs).

HOM™ 150 may also include a menu having a list of regulatory items that caregiver 130B must record. For example, Medicare has regulations that LTC facility 110B must comply with to receive reimbursements for products and services. The regulations may require caregiver 130B to check a resident 140B for bedsores, to turn resident 140B over a predetermined number of times, or to get resident 140B out of bed for exercise.

The menu items available to caregiver 130B may be customized for a particular LTC facility 110B and/or customized to a resident 140B. For example, suppose a LTC facility 110B has a recreation room, but not a courtyard. To customize HOM™ 150 to LTC facility 110B, the location menu having a list of locations in LTC facility 110B may include a recreation room, but not a courtyard. As another example, suppose a resident's 140B weight needs to be monitored based on a physician's instructions. HOM™ 150 may be customized so that caregiver 130B may report resident's 140B weight.

In addition to providing a mechanism for entering observations, HOM™ 150 may guide, direct, and monitor the nature and quality of caregiver's 130B actions. HOM™ 150 may be characterized as a constant management companion. HOM™ 150 brings a meaningful, measurable, and verifiable resident focus to all caregiver 130B behavior. HOM™ 150 overcomes the management control difficulties discussed above by facilitating a continuous flow of personnel monitoring, management, and maintenance activities. HOM™ 150 may be used to monitor caregiver's 130B actions to ensure that caregiver 130B is focusing on resident 140B by determining whether caregiver 130B is entering a predetermined volume of observations at a predetermined frequency. For example, administrator 120B may instruct caregiver 130B to enter twenty-four observations of a resident 140B over an eight hour period at a rate of three observations every hour. When caregiver 130B enters an observation into HOM™ 150, the observation may be time-stamped to determine when the observation was entered. Administrator 120B may monitor caregiver's 130B actions by retrieving the observations entered by caregiver 130B from the database 190. If caregiver 130B meets the requirements, then caregiver 130B may be rewarded. Once caregiver 130B learns that a record is being produced of his/her behavior and learns what behavior produces a reward, then caregiver 130B may change his behavior to receive a reward. HOM™ 150 serves to provide purpose and direction to caregiver 130B in a way that results in behaviors that are goal seeking, uniform, and unifying in culture. Thus, HOM™ 150 also facilitates behavior management.

Further, a management control system that enhances self-esteem and confidence is essential. Having confidence in knowing what to do and how to do it is a powerful contributor to the satisfaction of caregiver 130B, which may reduce caregiver 130B turnover rates. By continuously guiding caregiver's 130B actions, HOM™ 150 improves caregiver's 130B self-esteem and confidence.

Observation processing system 180 predicts risks by creating norms based on the observations received from HOM™ 150 and stored in the database 190. Based on observations on a resident 140B, the processing system 180 may determine a profile of resident 140B. The processing system 180 may detect a deviation in the profile of resident 140B, which may signal the processing system 180 to problems or increased risks.

The processing system 180 may flag anomalous behavior in a resident 140B based on the observations stored in the database 190. For example, suppose the observations stored in the database 190 indicate that a resident 140B usually plays cards four out of five days a week between 11:00 a.m. and 12:00 noon. If observations indicate that resident 140B is no longer playing cards, then the processing system 180 may determine that resident's 140B lack of playing cards is an anomalous behavior and may send a message to caregiver 130B via HOM™ 150 to check on resident 140B or interact with resident 140B to determine if there is a problem. The processing system 180 may also send a message to administrator 120B or some other person or entity (e.g., family member or doctor) when an anomalous behavior is discovered.

The processing system 180 may also create an anticipated agenda of resident's 140B activities based on the observations stored in the database 190. For example, data stored in the database 190 may suggest that resident 140B typically awakens at 8:00 a.m., eats breakfast at 8:30 a.m., takes a walk at 9:00 a.m., plays cards at 10:00 a.m., eats lunch at 12:00 noon, and watches television from 1:00 p.m. to 3:00 p.m. Based on this data, the processing system 180 may create an anticipated agenda of resident's 140B activities and transmit the anticipated agenda to caregiver 130B via HOM™ 150 or to some other person or entity.

The anticipated agenda builds predictability around the activities and behavior of resident 140B that may be useful in assisting resident 140B to fulfill the agenda, which may provide a more fulfilling lifestyle for resident 140B. For example, if the processing system 180 determines based on data stored in the database 190 that resident 140B likes to watch a particular television show at 1:00 p.m., but needs assistance changing the channel, the anticipated agenda created by the processing system 180 may include an entry that resident 140B is expected to watch the particular television show at 1:00 p.m. and needs assistance changing the channel. Once caregiver 130B receives the agenda via HOM™ 150, caregiver 130B could ensure that resident 140B is able to watch the television show at 1:00 p.m. by providing assistance to change the channel. Thus, by knowing resident's 140B agenda, caregiver 130B knows what to do to support the fulfillment of that agenda for resident 140B.

As another example, the processing system 180 may determine that resident 140B generally experiences a leg ache each day at the same time. The data stored in database 190 may include information on what has been done in the past to alleviate resident's 140B leg ache. The information may include successful and unsuccessful solutions to alleviate resident's 140B leg ache. Based on this information, the processing system 180 may transmit instructions to caregiver 130B via HOM™ 150 to check on resident's 140B at a specified time and may also suggest a solution to alleviate resident's 140B leg ache based on the successful solutions stored in the database 190.

Further, the processing system 180 may determine based on the data stored in the database 190 whether resident's 140B support needs have increased. If the processing system 180 determines that resident's 140B support needs have increased, then a message may be sent to caregiver 130B to provide additional support to resident 140B. This facilitates aging in place.

The processing system 180 may also produce reports based on the data stored in the database 190. For example, the processing system 180 may produce a report that caregiver 130B would typically have to prepare providing caregiver 130B with more time to spend with resident 140B.

Still further, the processing system 180 may assign one or more scores to a resident 140B. For example, the processing system 180 may assign a score for the general health of resident 140B and/or for the activity level of resident 140B. The processing system 180 may also assign a score relating to regulatory compliance. Scores for a group a residents 140B may also be assigned. The processing system 180 may compare one resident's score to another resident's score or to a group score. Further, the processing system 180 may detect a change in resident's score or the group's score. When the processing system 180 detects a change in resident's score or the group's score, the processing system 180 may notify caregiver 130B via HOM™ 150. The processing system 180 may also notify the administrator 120B or some other person or entity. A change in a resident's score or a group's score may indicate a problem with one or more caregivers 130B. For example, if resident's score or a group's score changes only when one or more caregivers 130B are working, then it may be determined that the one or more caregivers 130B are not properly performing their job.

The processing system 180 may also detect changes in resident's 140B social behavior and recreational activity based on the data stored in the database 190. Based on a change in resident's social behavior and/or activity score, the processing system 180 may predict the emotional state of resident 140B. For example, the processing system 180 may predict whether resident 140B is depressed, confused, afraid to take actions, or experiencing a loss of motivation or energy. A drop in the activity score may indicate that resident 140B is depressed or has lost motivation, for example. The processing system 180 may also infer whether resident 140B is experiencing a loss in personal management skills (e.g., unable to handle a bar of soap properly) or chronic indecision.

The processors 180 may determine based on the data stored in the database 190 the physical state of resident 140B. For example, the processing system 180 may detect whether resident 140B is experiencing memory loss or loss of mobility. The processing system 180 may also quantify the frailty of resident 140B. The processor 189 may detect whether resident 140B has Alzheimer's.

As mentioned above, caregiver's 130B Behavior Capital™ (i.e., caregiver's knowledge, skill sets, and attitude) may be improved through curriculum training. In one embodiment, curriculum training may be provided via distant learning (e.g., via Internet, videotape, CD-ROM, DVD, or other recording medium). Curriculum training may comprise three phases: instruction, modeling, and guided participation. During the instruction phase, caregiver 130B learns through instructions. That is, caregiver 130B learns through written and/or oral lessons. During the modeling phase, the written and/or oral lessons are reinforced through demonstrations of the lessons. The guided participation phase further reinforces the written and/or oral lessons by allowing caregiver 130B to practice what was learned during the previous phases. For example, suppose it is desired to teach caregiver 130B how to properly check a resident 140B for bedsores. Caregiver 130B receives written or oral lessons during the instruction phase on how to properly check for bedsores. If the curriculum training is being conducted via distant learning, caregiver 130B may receive written or oral lessons via the Internet or via a videotape, CD-ROM, DVD, or other recording medium. Alternatively, caregiver 130B may receive written or oral lessons in a classroom setting. During the modeling phase, caregiver 130B may see a demonstration on how to properly check for bedsores. During the guided participation phase, caregiver 130B practices (e.g. on a person or model) how to properly check for bedsores.

During curriculum training, caregiver 130B may gain knowledge on the aging process and aging issues, which include anything that may impact on the life of a resident 140B as they age. For example, caregiver 130B may gain knowledge on issues related to Alzheimer, memory loss, hearing loss, eyesight loss, strokes, cancer, or heart disease. Caregiver 130B may also gain knowledge on issues related to motion and mobility such as osteoporosis and arthritis. Still further, caregiver 130B may gain knowledge on issues related to injuries such as fractures, burns, bruises, contusions, and chronic pain.

Further, during the curriculum training, caregiver 130B learns how to observe and recognize problems in resident including social or behavior changes. For example, caregiver 130B may learn how to observe and recognize when a resident is having a stroke or suffering memory loss. Indicators or predictors of problems may include weight loss, hearing loss, falls, high blood pressure, and high cholesterol, which caregiver 130B may learn to recognize during the curriculum training. Caregiver 130B may also learn how to recognize suspicious, sluggish, incoherent, and/or radical behavior in resident 140B. Caregiver 130B may also learn how to recognize failing physical resources in resident 140B, such as hearing, eyesight, and muscular control.

Still further, during the curriculum training, caregiver 130B may learn skills that impact on the quality of life for resident 140B including skills that facilitate aging in place. For example, caregiver 130B may learn skills for helping a resident 140B that has suffered a stroke through a rehabilitative process. Caregiver 130B may also learn lifestyle enhancement behavior and strategies. This includes training caregiver 130B to interact with resident 140B in a way that brings comfort to resident 140B. This also includes training caregiver 130B to understand resident's 140B interest and to help resident 140B get involved in activities that support resident's 140B interest. Caregiver 130B may also learn risk avoidance strategies such as fall prevention. For example, caregiver 130B may learn how to determine if resident 140B is wearing appropriate shoes to prevent accidental falls.

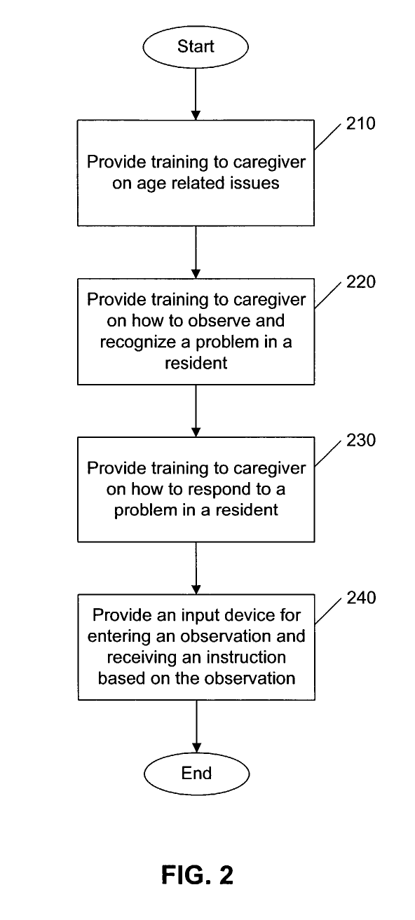

FIG. 2 illustrates a method for operating a LTC facility 110B consistent with the present invention. At stage 210, LTC facility 110B provides training to caregiver 130B on age related issues. Age related issues include anything that may impact on the life of a resident 110B as resident 110B ages. For example, age related issues may include issues related to at least one of the following: the aging process; age related medical problems such as strokes, cancer, heart disease; age related cognitive/memory problems such as Alzheimer, dementia, or memory loss; failing physical resources such as hearing loss, eyesight loss, or muscular control; motion and mobility problems such as osteoporosis and arthritis; injuries such as fractures, burns, bruises, contusions, and chronic pain; and psychological problems such as depression, confusion, or chronic indecision.

At stage 220, LTC facility 110B provides training to caregiver 130B on how to observe and recognize a problem in resident 140B. A problem may include any action, condition, or any other thing that has or may have an adverse affect (including physical, mental, or psychological affect) on resident 140B. For example, a problem may include a physical, mental, or psychological condition of resident 140B. Further examples of a problem include weight loss, high blood pressure, high cholesterol, social or behavior changes, suspicious behavior, sluggish behavior, incoherent behavior, radical behavior, a stroke, failing physical resources such as hearing, eyesight, and muscular control, or wearing inappropriate shoes.

At stage 230, LTC facility 110B provides training to caregiver 130B on how to respond to a problem. This may include training caregiver 130B in risk avoidance strategies. This may also include training caregiver 130B in lifestyle enhancement behavior and strategies. Still further, this may include training caregiver 130B on using HOM™ 150 to enter problems and receive solutions.

At stage 240, LTC facility 110B provides an input device to caregiver 130B for entering an observation and receiving an instruction based on the observation. The input device may be HOM™ 150 or any other handheld computer such as a palm pilot.

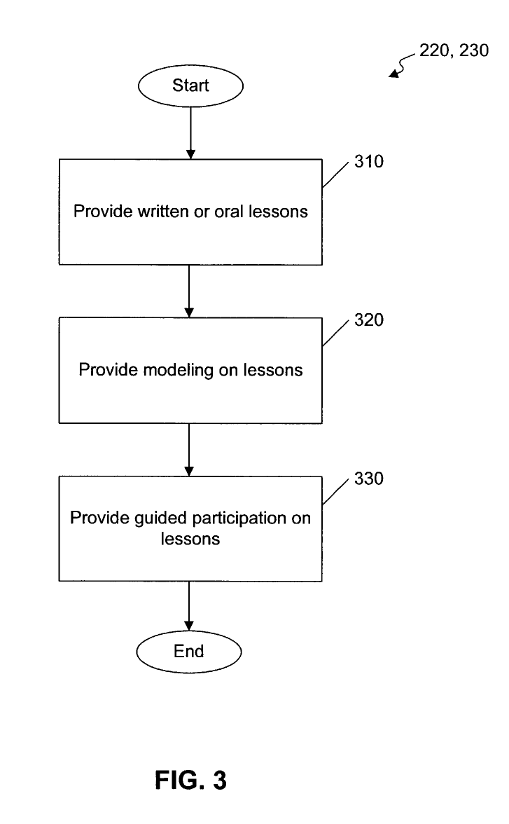

FIG. 3 illustrates a method for providing the training recited at stages 220 and 230. At stage 310, LTC facility 110B provides written or oral lessons. At stage 320, LTC facility 110B provides modeling on the lessons. At stage 330, LTC facility 110B provides guided participation on the lessons.

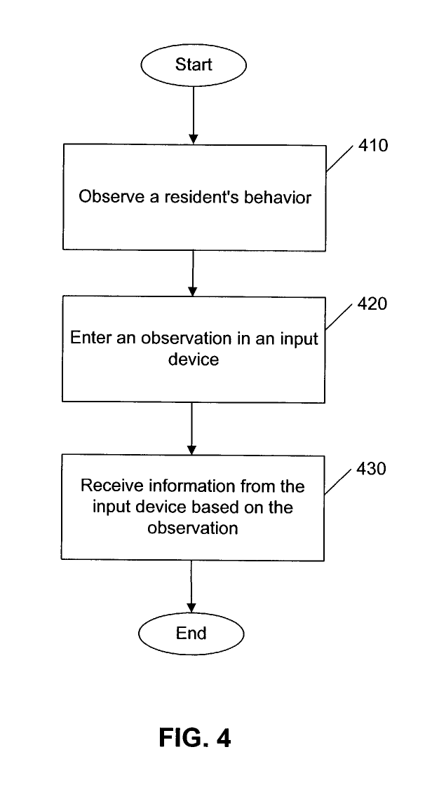

FIG. 4 illustrates a method for operating LTC facility 110B consistent with the present invention from caregiver's 130B point of view. At stages 410, 420, caregiver 130B observes resident 140B and enters an observation in an input device. An observation may include any action, condition, or anything else observed. As discussed above, generally, for each observation, caregiver 130B reports resident's 140B activity, resident's 140B location, and the time of day. Caregiver 130B may also observe and report resident's 140B response to caregiver's 130B interactions with resident 140B. The input device may be a HOM™ 150 or any other handheld computer such as a palm pilot.

At stage 430, caregiver 130B receives information from the input device based on the observation. Information may include a command, a suggestion, a warning, or any other information. As discussed above, the input device may return a warning of anomalous behavior, one or more suggestions for assisting resident 140B, or an anticipated agenda of resident 140B.

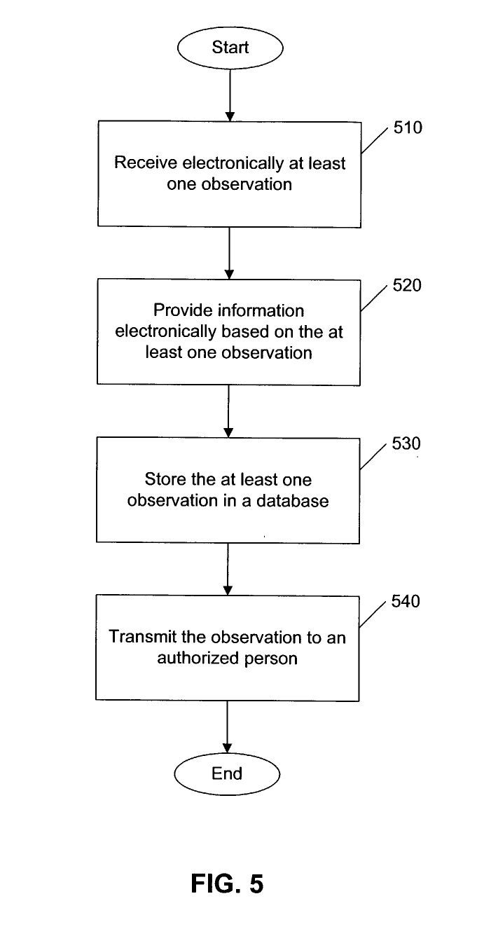

FIG. 5 illustrates a method for operating LTC facility 110B consistent with the present invention from the observation processing system's 180 point of view. At stage 510, system 180 receives electronically at least one observation. At stage 520, system 180 provides information electronically based on the at least one observation. Information may include a command, a suggestion, a report, a warning, or any other information. For example, system 180 may send a message to administrator 120B, caregiver 130B, or some other person or entity when an anomalous behavior is discovered or may send an anticipated agenda of resident's 140B to caregiver 130B or some other person or entity. As another example, system 180 may produce reports based on the observation. At stage 530, system 180 stores the at least one observation in database 190.

At stage 540, system 180 transmits the observation to an authorized person such as a family member, a solution provider (e.g., a physician), or any other person or entity that has permission to receive the observation.

Other embodiments of the invention will be apparent to those skilled in the art from consideration of the specification and practice of the invention disclosed herein. For example, HOM™ 150 and observation processing system 180 may be used in any industries where controlling complex behavior is desirable. It is intended that the specification and examples be considered as exemplary only, with a true scope and spirit of the invention being indicated by the following claims.

What is claimed is:

1. A method for operating a long term care facility, comprising:
observing a resident's behavior;
entering at least one observation in an input device; and
receiving information from the input device based on the at least one observation.

2. The method according to claim 1, wherein the input device is a handheld device.

3. The method according to claim 1, wherein the at least one observation is time-stamped when entered.

4. The method according to claim 1, wherein the at least one observation comprises the resident's activity.

5. The method according to claim 1, wherein the at least one observation comprises the resident's location.

6. The method according to claim 1, wherein the at least one observation comprises the resident's response to an event.

7. The method according to claim 1, wherein the information received comprises an indication of anomalous behavior.

8. The method according to claim 1, wherein the information received comprises an anticipated agenda.

9. The method according to claim 1, wherein the information received comprises information for assisting the resident.

10. A method for operating a long term care facility, comprising:
receiving electronically at least one observation;
providing information electronically based on the at least one observation; and
storing the at least one observation in a database.

11. The method according to claim 10, wherein the at least one observation comprises a resident's activity.

12. The method according to claim 10, wherein the at least one observation comprises a resident's location.

13. The method according to claim 10, wherein the at least one observation comprises a resident's response to an event.

14. The method according to claim 10, wherein the information provided comprises anomalous behavior.

15. The method according to claim 10, wherein the information provided comprises an anticipated agenda of a resident.

16. The method according to claim 10, wherein the information provided comprises information for assisting a resident.

17. The method according to claim 10, wherein the information provided comprises a report.

18. The method according to claim 10, further comprising transmitting the at least one observation and/or the information provided to an authorized person.

19. The method according to claim 10, further comprising determining whether a caregiver has entered a predetermined volume of observations at a predetermined frequency.

20. The method according to claim 10, further comprising processing the at least one observation to determine anomalous behavior.

21. The method according to claim 10, further comprising processing the at least one observation to determine an anticipated agenda of a resident.

22. The method according to claim 10, further comprising processing the at least one observation to determine information for assisting a resident.

23. The method according to claim 10, further comprising processing the at least one observation to produce a report.

24. The method according to claim 10, further comprising processing the at least one observation to determine whether a resident's support needs have increased.

25. The method according to claim 10, further comprising processing the at least one observation to determine a score for a resident.

26. The method according to claim 10, further comprising processing the at least one observation to predict an emotional state of a resident.

27. The method according to claim 10, further comprising processing the at least one observation to predict a physical state of a resident.

28. The method according to claim 10, further comprising processing the at least one observation to determine a future solution for a resident.

29. A method for operating a long term care facility, comprising:
providing training to a caregiver on age related issues;
providing training to a caregiver on how to recognize a problem in a resident;
providing training to a caregiver on how to respond to a problem in a resident; and
providing an input device for entering an observation and receiving information based on the observation.

30. The method according to claim 29, further comprising:
providing the observation electronically to an authorized person.

31. The method according to claim 29, wherein at least one of providing training to a caregiver on how to recognize a problem in a resident or providing training to a caregiver on how to respond to a problem in a resident comprises:
providing written or oral lessons;
providing modeling on the lessons; and
providing guided participation on the lessons.

32. The method according to claim 31, wherein at least one of providing written or oral lessons or providing modeling on the lessons is provided via distant learning.

33. A method for operating a long term care facility, comprising:
increasing a caregiver's knowledge on age related issues;
increasing a caregiver's ability to recognize a problem in a resident; and
increasing a caregiver's ability to respond to a problem in a resident.

34. A system for operating a long term care facility, comprising:
means for entering an observation; and
means for receiving information based on the observation.

35. The system according to claim 34, wherein means for entering an observation and means for receiving information comprises a handheld computer.

36. The system according to claim 34, wherein the means for entering an observation comprises at least one menu having a plurality of predetermined observations.

37. The system according to claim 36, wherein the predetermined observations comprise mutually exclusive behavior.

38. The system according to claim 36, wherein the predetermined observations comprise concomitant behavior.

39. The system according to claim 36, wherein the predetermined observations comprise locations in the long term care facility.

40. The system according to claim 36, wherein the predetermined observations comprise foods or drinks.

41. The system according to claim 36, wherein the predetermined observations comprise medication.

42. The system according to claim 36, wherein the predetermined observations comprise regulatory items.

43. The system according to claim 36, wherein the at least one menu is customized to the long term care facility.

44. The system according to claim 36, wherein the at least one menu is customized to a resident.

45. The system according to claim 34, further comprising:
means for providing the observation electronically to an authorized person.

46. The system according to claim 34, further comprising:
means for training a caregiver on age related issues;
means for training a caregiver on how to recognize a problem in a resident; and
means for training a caregiver on how to respond to a problem in a resident.

47. The system according to claim 46, wherein at least one of means for training a caregiver on how to recognize a problem in a resident or means for training a caregiver on how to respond to a problem in a resident comprises:
means for providing written oral lessons;
means providing modeling on the lessons; and
means for providing guided participation.

48. The system according to claim 47, wherein at least one of means for providing written or oral lessons or means for providing modeling on the lessons comprises an Internet connection.

49. A system for operating a long term care facility, comprising:
mean for receiving at least one observation;
a database for storing the observation; and
means for providing information based on the at least one observation.

50. The system according to claim 49, further comprising:
means for transmitting the observation to an authorized person.

51. A computer readable medium containing instructions for controlling a computer system to perform a method, the method comprising:
providing training to a caregiver on age related issues;
providing training to a caregiver on how to recognize a problem in a resident; and
providing training to a caregiver on how to respond to a problem in a resident.

52. The computer readable medium of claim 51, the method further comprising:
receiving an observation and providing information based on the observation.

53. The computer readable medium of claim 51, the method further comprising:
providing the observation electronically to an authorized person.

54. The computer readable medium of claim 51, wherein at least one of providing training to a caregiver on how to recognize a problem in a resident or providing training to a caregiver on how to respond to a problem in a resident comprises:
providing written or oral lessons; and
providing modeling on the lessons.

55. A computer readable medium containing instructions for controlling a computer system to perform a method, the method comprising:
receiving electronically at least one observation;
providing information electronically based on the at least one observation; and
storing the at least one observation in a database.

56. The computer readable medium of claim 55, the method further comprising determining whether a caregiver has entered a predetermined volume of observations at a predetermined frequency.

57. The computer readable medium of claim 55, the method further comprising processing the at least one observation to determine anomalous behavior.

58. The computer readable medium of claim 55, the method further comprising processing the at least one observation to determine an anticipated agenda of a resident.

59. The computer readable medium of claim 55, the method further comprising processing the at least one observation to determine information for assisting a resident.

60. The computer readable medium of claim 55, the method further comprising processing the at least one observation to produce a report.

61. The computer readable medium of claim 55, the method further comprising processing the at least one observation to determine whether a resident's support needs have increased.

62. The computer readable medium of claim 55, the method further comprising processing the at least one observation to determine a score for a resident.

63. The computer readable medium of claim 55, the method further comprising processing the at least one observation to predict an emotional state of a resident.

64. The computer readable medium of claim 55, the method further comprising processing the at least one observation to predict a physical state of a resident.

65. The computer readable medium of claim 55, the method further comprising processing the at least one observation to determine a future solution for a resident.

66. The computer readable medium of claim 55, the method further comprising transmitting the observation to an authorized person.
